(19) United States
(12) Patent Application Publication
(10) Pub. No.: US 2012/0004910 A1
(43) Pub. Date: Jan. 5, 2012

(54) System and method for speech processing and speech to text

(76) Inventors: Romulo De Guzman Quidilig, Los Angeles, CA (US); Kenneth Nakagawa, Beverly Hills, CA (US); Michiyo Manning, Los Angeles, CA (US)

(21) Appl. No.: 12/592,357

(22) Filed: Nov. 24, 2009

Related U.S. Application Data
(60) Provisional application No. 61/217,083, filed on May 7, 2009.

(51) Int. Cl. G10L 15/26

(52) U.S. Cl. 704/235; 704/E15.043

(57) ABSTRACT

Systems and method for processing speech from a user is disclosed. In the system of the present invention, the user's speech is received as input audio stream. The input audio stream is converted text that corresponds to the input audio stream. The converted text is converted to an echo audio stream. Then, the echo audio stream is sent to the user. This process is performed in real time. Accordingly, the user is able to determine whether or not the speech to text process was correct, or that his or her speech was corrected converted to text. If the conversion was incorrect, the user is able to correct the conversion process by using editing commands. The corresponding text is then analyzed to determine the operation which it demands. Then, the operation is performed on the corresponding text.

### RELATED APPLICATIONS

This patent application claims the benefit of priority under 35 USC sections 119 and 120 of U.S. Provisional Patent Application No. 61/217,083 filed May 7, 2009, the entire disclosure of which is incorporated herein by reference including its Drawings, Specification, Abstract, and Compact Disc (CD) Appendix.

### BACKGROUND

The present invention relates to systems and methods for human to machine interface using speech. More particularly, the present invention relates to systems and methods for increasing efficiency and accuracy of machine implemented speech recognition and speech to text conversion.

In automatic speech recognition arts, there are continuing efforts to improve accuracy, efficiency, and ease of use. In many applications, it is preferable to achieve very high (of perhaps over 95%) accuracy for automatic speech to text conversion is desired. Even after many years of research and development, automatic speech recognition systems fall short of expectations. There are many reasons for such shortcoming. These reasons may include, for example only, variations in dialects within the same language; context-driven meanings of speeches; use of idioms; differing personalities of the speaker; health or other medical conditions of the speaker; tonal variations; quality of the microphone, connection, and communications equipment; and so forth. Even the same person may speak in numerous different manners in different times, different situations, or both.

Because of existing technical deficiencies with machine speech to text systems, some speech recognition systems use human transcription personnel to manually convert speech to text, especially for words or phrases for which machines cannot do so. Using human transcription personnel to manually convert speech limits system capacity and processing speed. Such systems pose obvious limitations and problems such as the need to hire and to manage human operators and experts. Additionally, such systems create potential privacy and security risks from the fact that the human operators must listen to the speaker's messages during the process. Further, there is no provision to allow editing of the spoken messages before conversion, transmission, or both. Finally, in such systems, the speaker/user is typically required to pre-register online to establish an account and set-up other parameters. This requires access to a computer and network (e.g. Internet access).

Some existing systems embed speech recognition technology in portable devices such as a mobile phone. Such portable device typically includes a small screen and a compact keyboard allowing its user to visually edit recognized speech in real-time. However, such device does not provide a complete, hands-free solution. The device requires the user to view the small screen to validate the resulting text; to manipulate tiny keys to navigate; and to control the device. Moreover, existing speech-to-text programs for such devices are typically overly complex and large, requiring a degree of CPU power and hardware requirements that may push the limits of the portable device. Accordingly, for the existing speech to text technology for portable devices, not much capacity or capability is available for improvement and additional features. Finally, with such systems, the user is required to download and update the software for changes.

Accordingly, there remains a need for an improved speech recognition and speech to text conversion system that eliminates or alleviates these problems; provides improved accuracy, efficiency, and ease of use; or both.

### SUMMARY

The need is met by the present invention. In a first aspect of the present invention, a method for processing speech from a user is disclosed. First, user input is obtained by converting the user's speech into text corresponding to the speech. This is accomplished by receiving input audio stream from the user; converting the input audio stream to corresponding text; converting the corresponding text into an echo audio stream; providing the echo audio stream to the user; and repeating these steps until the corresponding text includes an end-input command. Then, the corresponding text is analyzed to determine a desired operation. Finally, the desired operation is performed.

The desired operation may be, for example, sending an electronic mail (email) message. In this case, the corresponding text is parsed to determine parameters of an email message including, for example, the addressee for the email. Alternatively, the desired operation may be, for example, sending an SMS (Short Message Service) message. In this case, the corresponding text is parsed to determine parameters of the SMS message. In some instances, the corresponding text may be divided into multiple portions with each portion having a size that is less than a predetermined size. The predetermined size may be, for example, the maximum number of characters or bytes allows to be sent in each SMS message. Then, each portion of the corresponding text as a separate SMS message. Alternatively, the desired operation may be, for example, sending an MMS (Multimedia Messaging Services) message. Alternatively, the desired operation may be, for example, translating at least a portion of the corresponding text.

Alternatively, the desired operation may be, for example, searching for information in the Internet. In this case, a request is encoded, the request including information from the corresponding text. The request is sent to a web service machine and the response from the web service machine is received. The response is converted to an audio stream and sent to the user.

In a second aspect of the present invention, a system for processing speech from a user is disclosed. The system includes a computing device connected to a communications network. The computing device includes a processor; storage for holding program code; and storage for holding data. The storage for holding program code and the storage for holding data may be a single physical storage device. The program code storage includes instructions for the processor to perform the steps described above with respect to the first aspect of the present invention.

In a third aspect of the present invention, a method for obtaining input from a user is disclosed. First, a prompt is provided to the user. Second, Input audio stream is received from the user. The input audio stream is converted to corresponding text. If the corresponding text is improper, then improper input feedback is provided to the user, and the method is repeated from the first step or the second step. If the corresponding text is an editing command, then the editing command is executed and the method is repeated from the first step or the second step. If the corresponding text is an end-input command, then the method is terminated. If the corresponding text is input text, then the following steps are taken: saving the corresponding text, converting the corresponding text into an echo audio stream; sending the echo audio stream to the user; and repeating the method from the first step or the second step.

In a fourth aspect of the present invention, a system for obtaining speech from a user, the system is disclosed. The system includes a computing device connected to a communications network. The computing device includes a processor; storage for holding program code; and storage for holding data. The storage for holding program code and the storage for holding data may be a single physical storage device. The program code storage includes instructions for the processor to perform the steps described above with respect to the third aspect of the present invention.

In a fifth aspect of the present invention, a method for processing speech from a user is disclosed. Input audio stream is received from the user. The input audio stream is converted to corresponding text. The corresponding text is saved. The corresponding text is converted into an echo audio stream. The echo audio stream is provided to the user. These above steps are repeated until the corresponding text includes a recognized command. Then, the recognized command is executed.

### BRIEF DESCRIPTION OF THE DRAWINGS

FIG. 1 illustrates an overview of the environment within which one embodiment of the present invention is implemented;

FIG. 2 illustrates an overview of a system including the present invention;

FIG. 3 illustrates a portion of the system of FIG. 2 in greater detail;

FIG. 4 illustrates another portion of the system of FIG. 2 in greater detail;

FIG. 5 is a flowchart illustrating an overview of the operations of the system of FIG. 2;

FIG. 6 is a flowchart illustrating one aspect of the operations of the system of FIG. 2 in greater detail;

FIGS. 7 is a flowchart illustrating another aspect of the present invention; and

FIG. 8 illustrates a portion of the system of FIG. 1 in a greater detail.

### DETAILED DESCRIPTION

### Introduction

The present invention will now be described with reference to the Figures which illustrate various aspects, embodiments, or implementations of the present invention. In the Figures, some sizes of structures, portions, or elements may be exaggerated relative to sizes of other structures, portions, or elements for illustrative purposes and, thus, are provided to aid in the illustration and the disclosure of the present invention.

The present invention illustrates a method and a system for receiving and processing user speech including a method and system for obtaining input from a user's speech. The method includes steps of receiving the speech (audio stream) from a user; performing speech to text conversion (to text that corresponds to the audio stream); then performing, using the corresponding text, a text to speech conversion (to echo audio stream); and sending the echo audio to the user. This is done in real time. This way, the user is able to determine whether or not the speech to text conversion from his original speech was performed correctly. If the speech to text conversion was not correct, the user is able to correct it using spoken editing commands.

Because the present invention system presents the user with a real-time echo of his or her input speech as it was understood (converted) by the system, the user is able to correct any conversion mistakes immediately. Further, the present invention system provides for a set of editing commands and tools to facilitate the user's efforts in correcting any conversion errors. Here, the term “echo” does not indicate that the present system provides a mere repeat of the user's speech input as received by the present system. Rather, the “echo” provided by the system is the result of a two step process where (1) the user's speech input is converted to text that corresponds to the speech input, and (2) the corresponding text is then converted into echo audio stream which is then provided to the user as the echo. Hence, if any one of the two steps is performed in error, then the words of the echo audio are dissimilar to the words of the original user input speech.

Thus, providing echo audio and allowing the user to correct his or her own input speech, the speech to text conversion becomes, in the end, error free. Thus, the present invention allows for a speech to text system free from errors; free from requirements of video output devices; free from requirements of keyboard input devices; and free from human intervention. Further, present invention allows for implementation of electronic mailing, SMS (Short Message Service) text transmission, translation, and other communications functions that are much improved compared to the currently available systems.

### System Overview

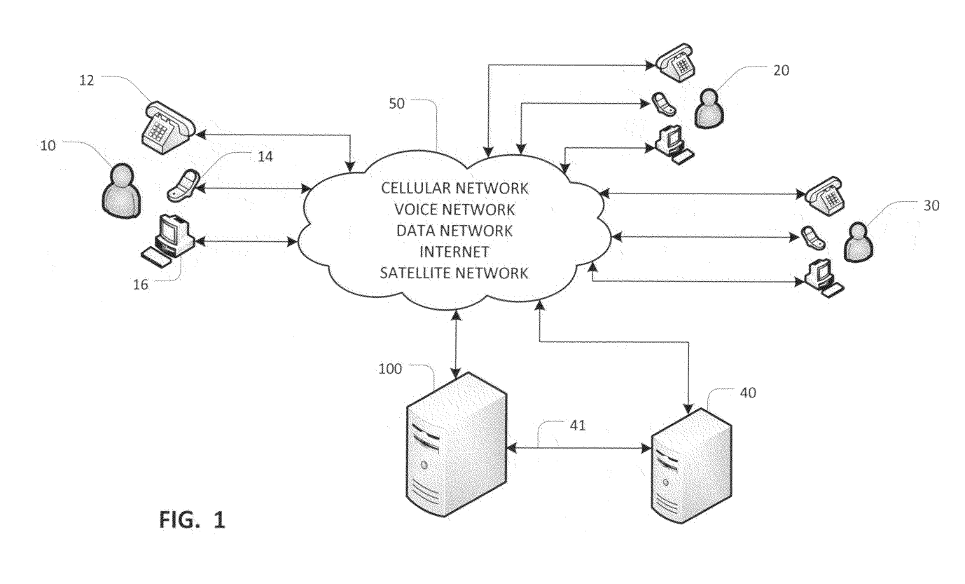

FIG. 1 illustrates an overview of the environment within which one embodiment of the present invention is implemented. Referring to FIG. 1, a system 100 in one possible embodiment of the present invention is implemented as a computing server apparatus 100 connected to a network 50. The network 50 can be any voice and data communications network, wired or wireless. For example, network 50 may include, without limitation and in any combination, cellular communications networks much of which are wireless; voice network such as telephone exchanges and PBX (private branch exchanges); data networks such as fiber-optic, cable, and other types; the Internet; and satellite networks.

The network 50 connects the server 100 to a plurality of people each of whom connects to the others as well as to the server 100. In the illustrated embodiment, users 10, 20, and 30 connect to each other as well as to the server 100 via the network 50. Each user, for example user 10, connects to the server 100 using one of a number of communications devices such as, for example only, a telephone 12, a cellular device such as a cellular phone 14, or a computer 16. Each of the other users 20 and 30 may use a similar set of devices to connect to the network 50 thereby connecting to the other users as well as to the server 100. The server 100 may also be connected to other servers such as a second server 40 for providing data, web pages, or other services. The server 100 and the second server 40 may be connected via the network 50 or maintain a direct connection 41. The second server 40 may be, for example, a data server, a web server, or such.

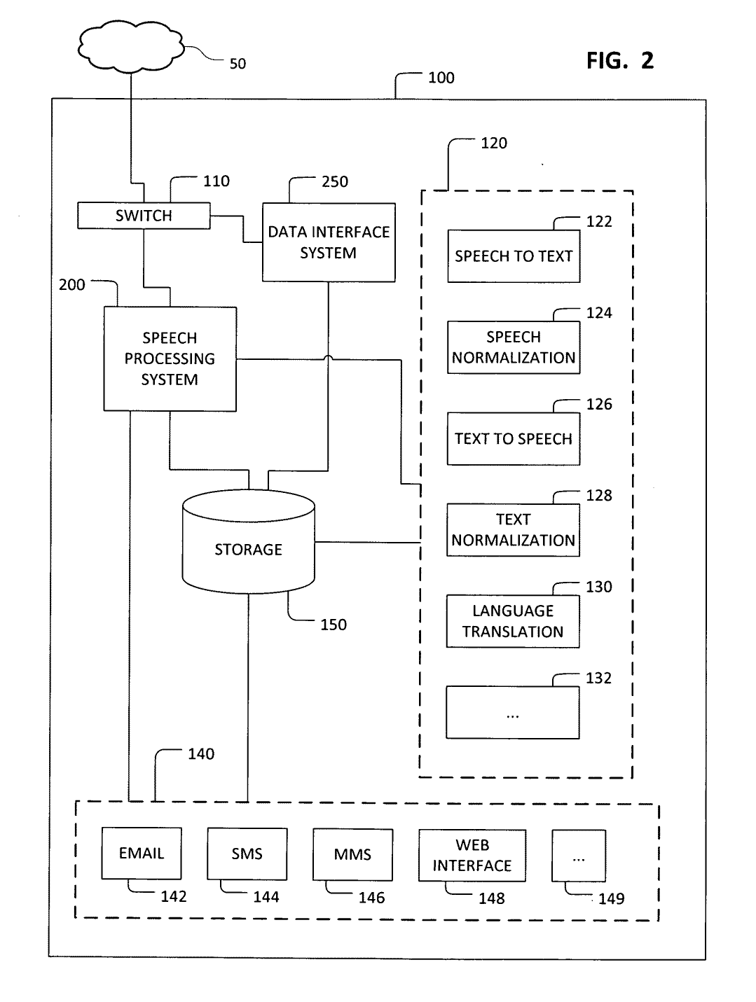

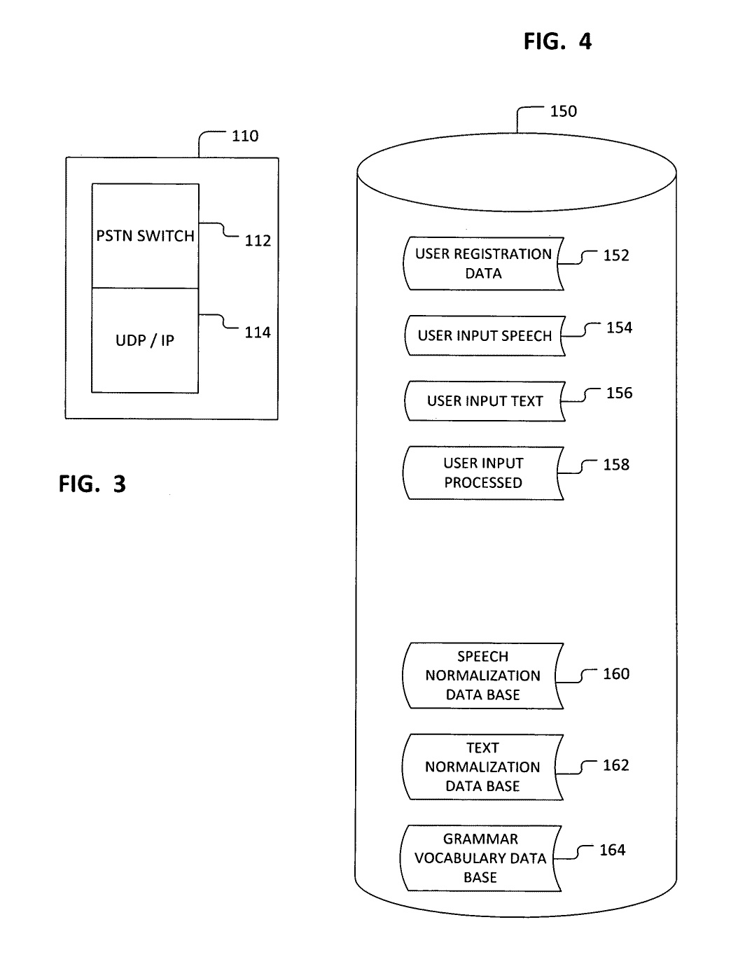

FIG. 2 illustrates a logical schematic diagram as an overview of the server 100. Referring to FIGS. 1 and 2, the server 100 includes a switch 110 providing means through which the server 100 connects to the network 50. The switch 110 is connected to a speech processing system 200. FIG. 3 illustrates the switch 110 in a greater detail. Referring to FIGS. 1 through 3, the switch 110 may include one or more public switched telephone network (PSTN) switches 112, User Datagram Protocol (UDP) 114, IP (Internet Protocol), or any combination of these. In addition, the switch 110 may include other hardware or software implemented means through which the server 100 connects to the network 50 and, ultimately, the users 10, 20, and 30. The switch 110 may be implemented as hardware, software, or both. The switch 110 is connected to a speech processing system 200 of the server 100. The speech processing system 200 may be implemented as a dedicated processing hardware or as software executable on a general purpose processor.

The server 100 also includes a library 120 of facilities or functions connected to the speech processing system 200. The speech processing system 200 is able to invoke or execute the functions of the function library 120. The function library 120 includes a number of facilities or functions such as, for example and without limitation, speech to text function 122; speech normalization function 124; text to speech function 126; text normalization function 128; and language translation functions 130. In addition to the functions illustrated in the Figures and listed above, the function library 120 may include other functions as indicated by box 132 including an ellipsis. Each of the member functions of the function library 120 is also connected to or is able to invoke or execute the other member functions of the function library 120.

The server 100 also includes a library 140 of application programs connected to the speech processing system 200. The speech processing system 200 is able to invoke or execute the application programs of the application program library 140. The application program library 140 includes a number of application programs such as, for example and without limitation, Electronic Mail Application 142; SMS (short message service) Application 144; MMS (multimedia messaging services) Application 146; and Web Interface Application 148 for interfacing with the Internet. In addition to the application programs illustrated in the Figures and listed above, the application program library 140 may include other application programs as indicated by box 149 including an ellipsis.

Portions of each of the functions of the function library 120 and the portions of the applications programs of the application programs library 140 may be implemented using existing operating systems, software platforms, software libraries, API's (application programming interfaces) to existing software libraries, or any combination of these. For example only, the entirety of speech to text function 122 may be implemented by the applicant or Microsoft Office Communications Server (MS OCS), a commercial product, can be used to perform portions of the speech to text function 122. Other useful software products include, for example only, and without limitation, Microsoft Visual Studio, Nuance Speech products, and many others.

The server 100 also includes an information storage unit 150. The storage 150 stores various files and information collected from a user, generated by the speech processing system 200, functions of the function library 120, and the application programs of the application program library 140. One possible embodiment of the storage 150 including various sections and data bases are illustrated in FIG. 4 and discussed in more detail below. The storage is also connected to the functions of the function library 120 and the application programs of the application program library 140 thereby allowing various functions and application programs to update various databases with the storage 150 as well as to access information updated, generated, or otherwise modified by the functions and application programs.

The server 100 also includes a data interface system 250. The data interface system 250 includes facilities that allow the user 10 access the server 100 via a computer 16 to set up his or her account and various characteristics of his or her account. For example, data interface system 250 may allow the user 10 to upload files that can be sent attached to an electronic mail. There are many ways to implement the data interface system 250 within the scope of the present invention. For example, data interface system 250 may be implemented using web pages including interactive menu features, interfaces implemented in XML (Extensible Markup Language), Java software platform or computer language, various scripting language, other suitable computer programming platforms or language, or any combination of these.

### Operations Overview

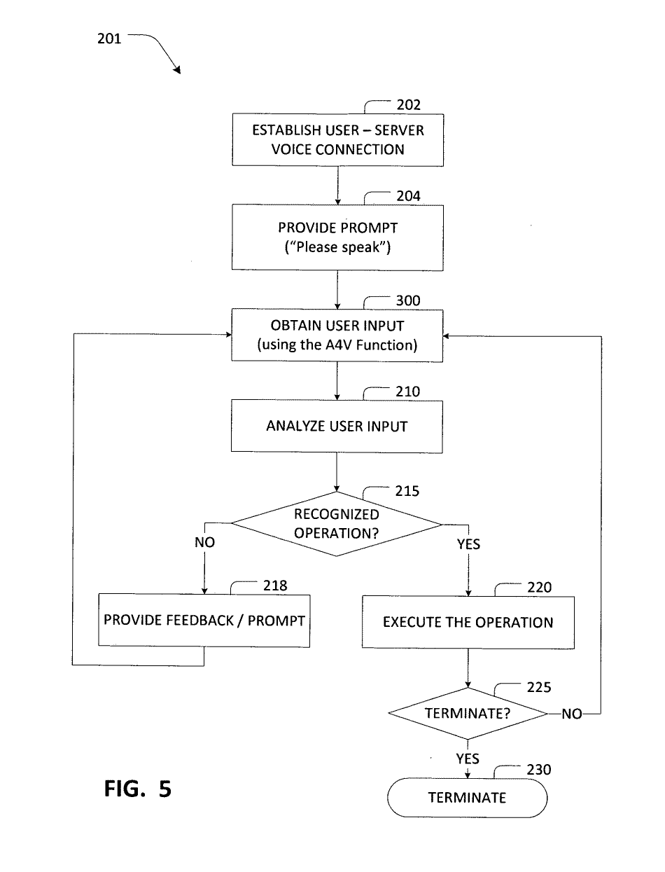

FIG. 5 is a flowchart 201 illustrating an overview of the operations of the system 100 of FIG. 2 as performed by the speech processing system 200 of FIG. 2. Referring to FIGS. 1, 2, and 5, a user, for example the user 10, initiates contact with the server 100 by calling a telephone number designated for the server 100. The server 100 accepts the call and establishes the user-server voice connection. Step 202. The server 100 then provides an audio prompt to the user 10. The audio prompt can be, for example only, “Please speak,” “Welcome,” or other prompting message. Step 204.

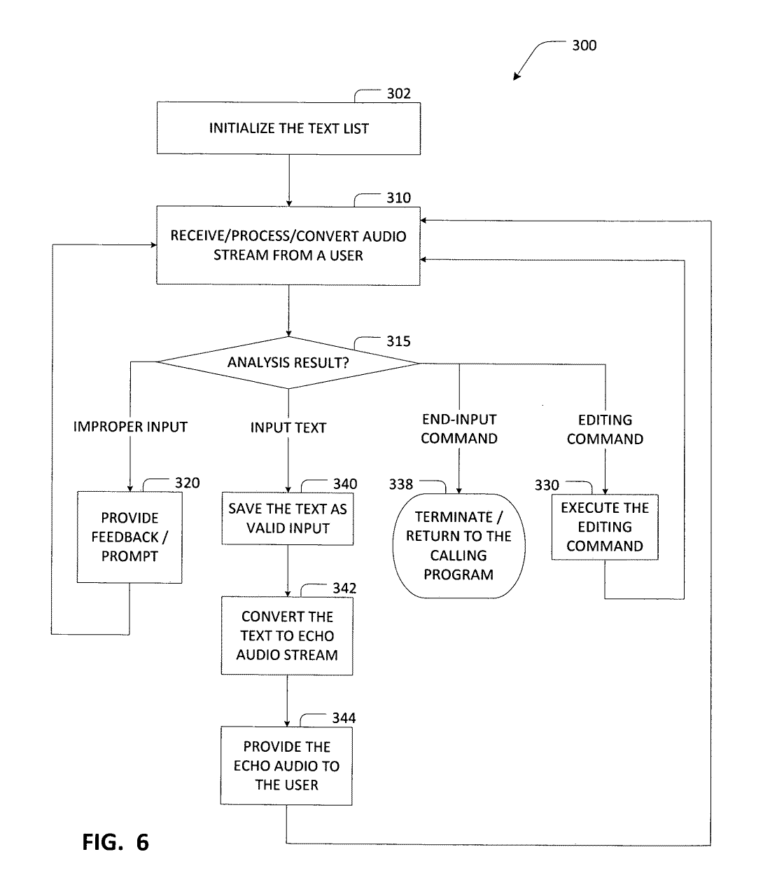

Then, the user 10 is free to speak to the server 100 to effectuate his or her desired operation such as to send an email message merely by speaking to the server 100. The user's speech is obtained by the server 100 in step 300 and converted to text as the user input. Details on the process of how the user input is obtained at step 300 are diagramed in FIG. 6 and discussed in more detail below. The user input is then parsed and analyzed. Step 210. Then, a determination is made as to whether or not the user input includes a recognized operation. Decision step 215. If the user input does not include a recognized operation, then the server 100 provides an audio feedback to the user indicating that the server 100 failed to recognize the operation. Such feedback may be, for example only, “Unknown operation. Please speak.” Step 218. Then, the operations 201 of the speech processing system 200 are repeated from step 300.

If the user input includes a recognized operation, then recognized operation is performed. Step 220. If the recognized operation is of the type (“termination type”) that would lead to the termination of the user-server connection, then the user-server connection is terminated. Decision step 225 and step 230. If the recognized operation is not a termination operation, then the operations 201 of the speech processing system 200 are repeated from step 300.

### Obtaining User Input

The step 300 of obtaining the user input is illustrated in greater detail in FIG. 6 as a flowchart 300 including a number of Sub-steps. For convenience, each of these “sub-steps” also referred to as “steps” herein and the step 300 is referred to as the method of obtaining user input. Referring to FIGS. 1 through 6, a user input text list 156 in the storage 150 is initialized. Step 302. This may involve emptying or clearing the user input text storage area. As the user 10 begins and continues to speak into a device such as his cellular telephone 14, the sound is converted into a stream of digitized electrical signals (“input audio stream”) by the cellular telephone 14 and sent over the network 50 to the server 100. At the server 100, the speech processing system 200 receives and processes the input audio stream by invoking the speech to text function 122. Step 310.

The speech to text function 122 continuously processes the input audio stream in real time or in near-real time to perform a number of actions. The speech to text function 122 detects parts of the input audio stream that correspond to slight pauses in the user's speech and separates the input audio stream into a plurality of audio segments, each segment including a portion of the input audio stream between two consecutive pauses. If there is a lengthy pause (pause for a predetermined length of time) in the user's speech (as indicated in the input audio stream), then an audio segment corresponding to the pause is formed. The speech to text function 122 converts each audio segment into text that corresponds to the words spoken by the user during that audio segment using speech recognition techniques. For the pause segment, the corresponding text would be null, or empty. If the audio segment cannot be recognized and converted to text, then the corresponding text may also be null. Null or empty input is an improper input. The corresponding text is provided to the speech processing system 200.

The speech to text function 122 sends the corresponding text to the speech processing system 200 for each audio segment. For the each audio segment, the corresponding text is analyzed to determine what actions to take, if any, in response to the user's entry of the corresponding text. Decision Step 315. If the corresponding text is determined to be an improper input, then an improper input feedback is sent to the user. Such feedback may be, for example only, audio stream “improper input” or an audio cursor such as a beep. Step 320. Then, the process 300 is repeated beginning at Step 310.

If the corresponding text is determined to be an editing command, then the editing command is executed. Step 330. Then, the process 300 is repeated beginning at Step 310. Editing commands are discussed in more detail below.

If the corresponding text is determined to be an end-input command, then the process step 300, the method of obtaining user input, is terminated and the control is passed back to the programmed that invoked the step 300. Termination step 338.

If the corresponding text is not improper, not an editing command, and not an end-input command, then the corresponding text is saved as valid input text. Step 340. The text may be saved in the storage 150 as user input text 156. In fact, the input audio stream, the audio segments, or both can be saved in the storage 150 as user input speech. 154. The corresponding text is converted to an echo audio stream using the text-to-speech function 126. Step 342. The echo audio stream is an audio stream generated by invoking the text to speech function 126 using the corresponding text as the input text. Step 342. The echo audio stream is sent to the calling device, cellular telephone 14 in the current example, of the calling user, the user 10 in the current example. Step 344. The cellular telephone 14 converts the echo audio stream to sound waves (“echo audio”) for the user 10 to listen. Then, the Steps of the process 300 are repeated beginning at Step 310.

The speech input received from the user 10 and converted into the user input text 156 is then analyzed. Step 210. For example, the user input text 156 is parsed and the first few words are analyzed to determine whether or not they indicate a recognized operation. Step 215. If the result of that analysis 210 is that the user input text 156 does not include a recognized operation, then an audio feedback is provided to the user 10. Step 218. Then, the process 201 is repeated beginning at Step 204 or Step 300, depending on the implementation. If the result of that analysis 210 is that the user input text 156 includes a recognized operation, then the indicated operation is performed. 220. Then, depending on the implementation and the nature of the operation performed, the user session can be terminated or the process repeated beginning at Step 300. This is indicated in the flowchart 201 by the Decision Step 225, the Termination Step 230, and the linking lines associated with these Steps.

### Electronic Mail (Email) Example

The operations of the system 100 illustrated as flowcharts 201 and 300 and additional aspect of the system 100 may be even more fully presented using an example of how it may be used to send electronic mail message using only voice interface. Referring to FIGS. 1 through 6, in one possible embodiment, the system 100 may be configured to allow the user 10 to send an electronic mail message to an electronic mail address using only his or her cellular telephone 14 and dictating the entire electronic mail message.

In the present example, the user 10 dials the telephone number associated with for the server 100. The server 100 accepts the call and establishes the user-server voice connection. Step 202. The server 100 then provides an audio prompt to the user 10. The audio prompt can be, for example only, “Please speak,” “Welcome,” or other prompting message. Step 204. Then, the system 100 executes Step 300, and more particularly, executes Step 302 by initializing the user input speech database 154 and the user input text database 156.

In the present example, the user 10 then speaks (“Sample Speech 1”) the following:

“send email to John at domain dot corn subject line test only email message hi john comma new line test only period question mark exclamation mark translate to spanish send now”

As the user 10 begins and continues to speak Sample Speech 1 into a device such as his cellular telephone 14, the sound is converted into a stream of digitized electrical signals (“input audio stream”) by the cellular telephone 14 and sent over the network 50 to the server 100. In the server 100, the speech processing system 200 receives and processes the input audio stream and by invoking the speech to text function 122. Step 310.

As the input audio stream representing Sample Speech 1 is received by the server 100, the input audio stream 1 is divided into a number of audio segments depending on the location of the pauses within the input audio stream. It is possible that the user 10 spoke Sample Speech 1 in a single, continuous utterance. However, it is more likely that there were a number of pauses. For the purposes of the present discussion, Sample Speech 1 is separated into the following audio segments:

| Audio Segment | Corresponding Text (Audio Segment Text) |
|---|---|
| Audio Segment 1 | send email to John at domain dot com |
| Audio Segment 2 | subject line test only |
| Audio Segment 3 | hi john comma |
| Audio Segment 4 | new line test only period question mark exclamation |
| | mark |
| Audio Segment 5 | translate to spanish |
| Audio Segment 6 | send now |

Referring more specifically to FIGS. 5 and 6 but also generally to FIGS. 1 through 4, each audio segment of Sample Speech 1 is then converted into corresponding text by the speech to text function 122. Step 310. Then, each audio segment of Sample Speech 1 is analyzed, Decision Step 315.

In the current example, Audio Segment 1 is received and converted into text corresponding to Audio Segment 1.Step 310. Since the corresponding text is not an improper input and it is neither an editing command nor an end-input command, the corresponding text (for Audio Segment 1) is saved as a valid input text. Step 340. That is, the corresponding text “send email to John at domain dot com” is saved in the user input text database 156. Step 340. An echo audio stream is generated by converting the corresponding text, in the present example “send email to John at domain dot com” into an electronic stream representing the words of the corresponding text. Step 342. The echo audio stream is then provided to the user 10 by sending the echo audio stream to the user 10 via the network 50 to the cellular telephone 14. Step 344. The cellular telephone 14 converts the echo audio stream to physical sound (“echo audio”) for the user 10 to hear. Step 342 and 344 are performed sequentially. Step 342 and 344, together, may be performed before, after, or at the same time as Step 340. The Step 300 including is performed in real time or near real time.

Step 342 and 344 are performed to provide feedback to the user 10 as to the result of the speech to text conversion. As the user 10 listens to the echo audio, the user 10 is able to determine whether or not the most recent audio segment of the user's speech was correctly converted into text. If the user needs to correct that audio segment, the user 10 is able to use editing commands to do so. A number of editing commands are available and discussed in more detail herein below.

In the present example, Audio Segments 2 through 6 are likewise processed with each Audio Segment having its corresponding text saved in the user input text database 156. Also, for each Audio Segments 2 through 6, the corresponding text is used to generate a corresponding echo audio stream which is provided to the user 10.

When Audio Segment 6 is received and processed, Step 310, it is converted to corresponding text “send now.” At Decision Step 315, the corresponding text is recognized as an end-input command. Thus, the control is returned to the calling program or routine. In this case, the control is passed back to the flowchart 201 of FIG. 4. Therefore, the Step 300 is terminated at termination Step 338. At this stage, the user input text 156 includes the corresponding text of Audio Segments 1 through 5.

At Step 210, the user input text 156 is analyzed. For example, the first few words of the user input text database 156 are examined to determine whether or not these words include a recognized operation. Decision Step 215. If no recognized operation is found within the first few words of the user input text database 156, then a feedback is provided to the user 10. Such feedback may be, for example only, “Unknown operation” or such. Step 218. Then, the operations 201 are repeated beginning at Step 300.

In the present example, the user input text database 156 includes the following: “email John at domain dot com subject line test only email message hi john comma new line test only period question mark exclamation mark attach file filename dot doc”. In the user input text database 156, “send email to” is a recognized operation.

Operations are recognized by comparing the first words of the input text base 156 with a predetermined set of words, phrase, or both. For example, the input text base 156 is compared with a predetermined set of words or phrases: email; send email; send electronic mail; please send email; please send electronic mail; text; send text; send text to; please send text; send sms; please send sms; mms; send mms; please send mms. Each of these words or phrases corresponds to a desired operation. For example, each word and phrase in the set (email; send email; send electronic mail; please send email; please send electronic mail) corresponds to the email operation 142; and each word and phrase in the set (text; send text; send text to; please send text;) corresponds to send sms text operation 144. Depending on the implementation and the desired characteristics of the system 100, the predetermined set of words or phrases as well as the available operation to which the predetermined set of words or phrases corresponds to the available operation can vary widely. It is envisioned that in future systems, many more operations will be available within the scope of the present invention; further, it is envisioned that, for each available operation, currently implemented or envisioned for the future, many, many predetermined words and phrases can be used to correspond to each of the available operation within the scope of the present invention.

In the present example, the first word “email” of the input text base 156 matches “email,” one of the predetermined word corresponding to the email operation. Accordingly, at Step 220, the Electronic Mail Application 142 is invoked.

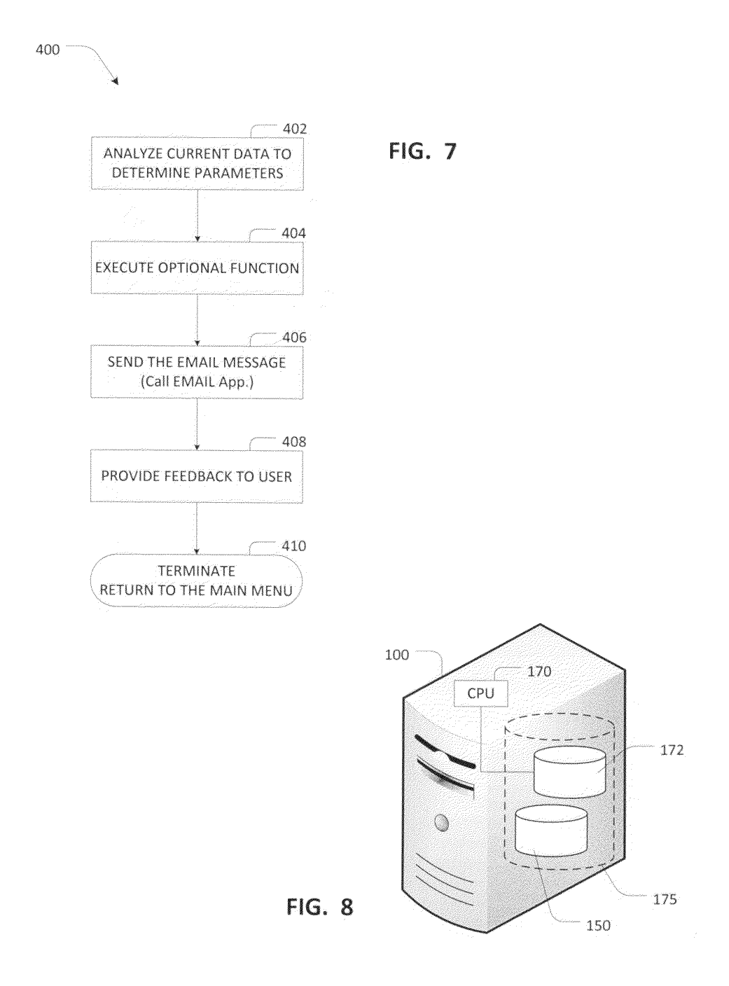

FIG. 7 includes flowchart 400 illustrating the operations of the email application 142 in greater detail. Continuing to refer to FIGS. 1 through 6 but also referring now to FIG. 7, the Electronic Mail Application 142 parses and analyzes the user input text database 156 to obtain the necessary parameters to send an electronic mail message. Step 402. In the present example, the Electronic Mail Application 142 parses and analyzes the user input text database 156 to formulate the following electronic message:

| Field: | Field Value: |
|---|---|
| From (Sender electronic mail address): | Rom@All4Voice.com |
| To (Addressee): | John@Domain.com |
| Subject: | Test only |
| Message: | Hi John, |
| | Test only.?! |
| Optional Function Command | Translate to |
| Optional Function Parameter | Spanish |

In the above sample electronic mail message table, the field value for the Sender electronic mail address is obtained from the user registration database 152. This is possible because the server 100 typically knows the cellular telephone number (the “caller ID”) assigned to the user 10. The user registration database 152 includes information correlating the caller ID with an electronic mail address of the user 10.

The address information is determined from text “John at domain dot com”. The Subject line is determined from text “subject line test only”. The text of the message is determined from text “email message hi john comma new line test only period question mark exclamation mark”.

Further, note that for the addressee's electronic mail address, “John at domain dot com” is converted to correspond to “John@domain.com”. This is a part of the Text Normalization process accomplished by a Text Normalization Function 128 of the serer 100. Also normalized is the message text. The raw message is normalized to contain appropriate capitalization, punctuation marks and such. The normalization process may be optionally used, not used at all, or only used in parts. That is, the user 10 may have options in his or her registration data 152, various optional parameters one of which may be the option to use the Normalization Function 128. The registration data 152 may include other information such as a contact list with contact names and one or more contact email address for each of the contact name. In that case, the recipient of an email or a text message may state the addressee's name rather than the email address, and the email address would be found by the system 100 using the contact list.

In addition to analyzing the and analyzes the user input text database 156 to obtain the necessary parameters to send an electronic mail message, the input text database 156 is analyzed to determine whether or not it includes Optional Function Commands. Optional Function commands are text within the user input text database 156 that indicate operations that should be performed, typically but not necessarily, before performing the desired operation. This analysis is also performed at Step 402.

The determination of whether or not the input text database 156 includes an Optional Function command is performed by comparing the last few words of the input text database 156 with predetermined set of words, phrase, or both. For example, the input text base 156 is compared with a predetermined set of words or phrases: translate to; and attach file. Each of these words or phrases corresponds to a desired Optional Function. For example, phrase “translate to” corresponds to the language translation operation 130. Depending on the implementation and the desired characteristics of the system 100, the predetermined set of words or phrases as well as the available Optional Functions to which the predetermined set of words or phrases corresponds to can vary widely. It is envisioned that in future systems, many more Optional Functions will be available within the scope of the present invention; further, it is envisioned that, for each Optional Functions, currently implemented or envisioned for the future, many, many predetermined words and phrases can be used to correspond to each of the Optional Functions within the scope of the present invention. Further, an Optional Function may have one or more parameters further describing or limiting the Optional Function.

If it is determined that the input text database 156 includes an Optional Function, then the Optional Function is executed, usually before the desired operation is performed. Step 404. In the present example, the Optional Function is “translate” and its parameter, the Optional Function Parameter is “Spanish.” Accordingly, in the present example, the Subject Line, the Message Text, or both are translated to Spanish, and the translated text, in Spanish, is then sent via email to the recipient. Step 406.

This is easily accomplished using known technology such as server computers implementing any of the following protocols: SMPT (Simple Mail Transfer Protocol), POP (Post Office Protocol), IMAP (Internet Message Access Protocol).

Then, optionally, feedback may be provided to the user. For example, an audio beep or “email sent” audio may be sent. Step 408. Control is passed back to the calling program. Step 410. Then, depending on implementation, the system 200 may terminate the user-server connection or the operations 201 of the speech processing system 200 are repeated from step 300. This is indicated in the flowchart 201 by the Decision Step 225, the Termination Step 230, and the linking lines associated with these Steps. This decision is implementation dependent.

### Editing Commands

Referring to FIGS. 1 through 6 but most specifically to FIG. 6 and Step 300, during the process of obtaining input from the user, the system 200 provides for a number of editing commands that the user may use to edit the Corresponding Text to correct any errors, mistakes in speech to text process, or both.

For example only, if Audio Segment 1 was converted at Step 310 to an incorrect corresponding text of “email Don at domain dot com,” then the incorrect corresponding text would be converted to the echo audio stream and provided to the user 10 via the cellular telephone 14. Upon hearing the echo audio stream including the audio equivalent of the incorrect corresponding text, the user 10 would realize that his or her speech “email John at domain dot corn” was incorrectly converted to “email Don at domain dot corn”. Accordingly, the user 10 is able to correct that particular audio segment before continuing to dictate the next audio segment. The correct is realized by the user speaking the following editing command: “delete that”. That command is recognized as the editing command at Decision Step 315 and is executed at Step 330. The editing commands and their effects are listed below:

| Editing | |
|---|---|
| Command | Effect of the Command |
| correct that | (1) Provide alternate conversions of the input audio stream into text; |
| | (2) For each of the alternate conversion, generate an echo audio stream |
| | and send to the user; |
| | (3) Provide a mechanism for the user to select from the alternate |
| | conversions. |
| back space | (1) Edit the most recent (just dictated and converted) Audio Segment Text |
| | by deleting the last character of the Audio Segment Text; |
| | (2) Generate an echo audio stream by converting the edited Audio |
| | Segment Text into an electronic stream representing the words of the |
| | text; and |
| | (3) Send the echo audio stream to the user. |
| delete all | (1) Clear the user input text 156; and |
| | (2) Send an audio cursor to the user. |
| delete that | (1) Delete the most recent (just dictated and converted) Audio Segment |
| | Text; |
| | (2) Set the most recent previous Audio Segment Text as the most recent |
| | Audio Segment Text |
| | (3) Generate an echo audio stream by converting the new most recent |
| | Audio Segment Text into an electronic stream representing the words |
| | of the text; and |
| | (4) Send an audio cursor to the user. |
| delete word | (1) Edit the text of the most recent (just dictated and converted) Audio |
| | Segment Text by deleting the last word; |
| | (2) Generate an echo audio stream by converting the edited Audio |
| | Segment Text into an electronic stream representing the words of the |
| | text; and |
| | (3) Send the echo audio stream to the user. |
| delete a word | Same as “delete word” command |
| spell that/start | Change to spelling mode (used when the speech to text process has failed |
| spelling | to recognized a word or a phrase). In this mode, the Step 300 is called |
| | recursively with a different set of Edit Commands and End-Input |
| | Commands such that each Audio Segment is converted to a |
| end spelling | Exit the spelling mode and return to the calling routine. |
| read all | (1) Generate an echo audio stream by converting the entire user input text |
| | 156 into an electronic stream representing the words of the text; and |
| | (2) Send the echo audio stream to the user. |
| select all | Select the entire user input text 156 |
| select that | Select the text of the most recent (just dictated and converted) Audio |
| | Segment Text. |
| bold all | Mark the entire user input text 156 for bold font |
| bold that | Mark the selected portion of the user input text 156 for bold font |
| underline all | Mark the entire user input text 156 for underline font |
| underline that | Mark the selected portion of the user input text 156 for underline font |
| italicise all | Mark the entire user input text 156 for italicise font |
| italicize that | Mark the selected portion of the user input text 156 for italicise font |
| pause that/go | continue to process further speech but ignore all input until “resume” or |
| to sleep/sleep | “wake up” is detected |
| now | |
| resume now/ | Resume at step 300 of FIG. 5. |
| wake up | |

### End-Input Commands

Referring to FIGS. 1 through 6 but most specifically to FIG. 6 and Step 300, during the process of obtaining input from the user, the system 200 provides for a number of commands for the user to indicate the end of text input process, also referred to as the method of obtain user input and generally referred to as the process or flowchart 300. The end-input commands and their effects are listed below:

| Editing Command | Effect of the Command |
|---|---|
| finish dictation | Signals the end of the input process of Step 300. |
| done dictation | |
| send now | |
| submit now | |

### Recognized Operations

Referring to FIGS. 1 through 6 but most specifically to FIGS. 2 and 5, and to Steps 215 and 220, the Recognized Operation of the system 200 depends on the implementation. Truly, the number of Recognized Operations can be very large and is limited only by any particular implementation. In the present example system 100, the implemented Operations include the following:

| Predetermine Words or Phrase | |
|---|---|
| indicating the Recognized Operation | Corresponding Operation |
| [please] [send] [an] [email\|electronic | Send Email, Application 142 |
| email\|mail] | |
| [please] [send] [an] [sms\|text\| | Send SMS Text Message |
| text message] | Application 144 |
| [please] [translate] [to] [language | Translate the input text |
| supported] [input text] | |
| [input text] [translate] [to] [language | Translate the input text |
| supported] | |
| [please] [tell me] [where\|who\|what\|how\| | Web Interface Application 148 |
| when] [input text] | |
| [go to] [www.domain.com] | Web Interface Application 148 |
| [search the web] [browse the web] | Web Interface Application 148 |
| [input text] | |

Where the [text within a square bracket] indicates an optional text and the vertical bar indicates an alternative text.

### SMS Example

Another example of an available Operation is to allow the user 10 to send SMS (Short

Message Service or Silent Messaging Service) text message using only voice interface. Continuing to refer to FIGS. 1 through 6, the system 100 is configured to allow the user 10 to send an SMS text message to using only his or her cellular telephone 14 and dictating the entire SMS text message.

In the present example, the user 10 dials the telephone number associated with for the server 100. The server 100 accepts the call and establishes the user-server voice connection. Step 202. The server 100 then provides an audio prompt to the user 10. The audio prompt can be, for example only, “Please speak,” “Welcome,” or other prompting message. Step 204. Then, the system 100 executes Step 300, and more particularly, executes Step 302 by initializing the user input speech database 154 and the user input text database 156.

In the present example, the user 10 then speaks (“Sample Speech 1”) the following:
“send email to John at domain dot corn subject line test only email message hi john comma new line test only period question mark exclamation mark translate to spanish send now”

As the user 10 begins and continues to speak Sample Speech 1 into a device such as his cellular telephone 14, the sound is converted into a stream of digitized electrical signals (“input audio stream”) by the cellular telephone 14 and sent over the network 50 to the server 100. In the server 100, the speech processing system 200 receives and processes the input audio stream and by invoking the speech to text function 122. Step 310.

Submitted herewith are two Compact Disc-Recordable (CD-R) media, each CD-R media meeting the requirements set forth in 35 C.F.R. section 1.51(e). These are submitted as a Computer Program Listing Appendix under 37 C.F.R. Section 1.96. The first of the two CD-R media (CD-R Copy 1) conforms to the International Standards Organization (ISO) 9660 standard, and the contents of the CD-R Copy 1 are in compliance with the American Standard Code for Information Interchange (ASCII). The CD-R Copy 1 is finalized so that they are closed to further writing to the CD-R. The CD-R Copy 1 is compatible for reading and access with Microsoft Windows Operating System. The files and their contents of the CD-R Copy 1 are incorporated herein by reference in their entirety. The following table lists the names, sizes (in bytes), dates, and description of the files on the CD-R Copy 1. The second of the two CD-R media (CD-R Copy 2) is a duplicate of CD-R Copy 1 and, accordingly, include the identical information in the identical format as CD-R Copy 1. The files and their contents of the CD-R Copy 2 are incorporated herein by reference in their entirety.

The information contained in and on the CD-R discs incorporated by reference herein include computer software, sets of instructions, and data files (collectively referred to as “the software”) adapted to direct a machine, when executed by the machine, to perform the present invention. Further, the software utilizes software libraries, application programming interfaces (API's) and other facilities provided by various computer operating systems; software development kits (SDK's); application software; or other products, hardware or software, available to assist in implementing the present invention. Operating systems may include, for example only, Microsoft Windows®, Linux, Unix, Mac OS X, Real-Time Operating Systems, Embedded Operating Systems, and others. Application software may include, for example only, Microsoft Office Communications Server (MS OCS) and Microsoft Visual Studio. MS OCS is a real-time communications server providing the infrastructure for enterprise level data and voice communications.

| File Name | Size (Bytes) | Date | Type and Description |
|---|---|---|---|
| allkeywords.grxml.txt | 680,866 | Sep. 25, | Optional source of grammar rules if |
| | | 2009 | default database grammar is not used. |
| | | | The actual grammar is actually |
| | | | loaded into memory from the database |
| | | | grammar. |
| app.config.txt | 881 | Jun. 04, | Contains application settings for the |
| | | 2009 | speech project; written in XML format. |
| AssemblyInfo.cs.txt | 1,193 | Mar. 08, | General Information about the assembly |
| | | 2009 | such as Title, Description, |
| | | | Configuration, Company, Product, Copyright, |
| | | | Trademark, Culture |
| | | | and Version information |
| Library.grxml.txt | 88,562 | Mar. 08, | A default grammar library. The library |
| | | 2009 | grammar contains perhaps hundreds of |
| | | | rules for recognizing times, dates, |
| | | | numbers, and other common utterances. |
| | | | By default, both a grammar library and |
| | | | new grammar are added, |
| | | | and the new grammar file is a |
| | | | Conversational Grammar Builder |
| | | | grammar. Another choice for a new |
| | | | grammar is a Speech Grammar Editor |
| | | | grammar |
| manifest.xml.txt | 605 | Mar. 08, | XML Document. This file is auto- |
| | | 2009 | generated file by Microsoft ® Visual |
| | | | Studio NET. The solution manifest |
| | | | (called manifest.xml) is stored at the root |
| | | | of a solution file. This file defines the list |
| | | | of features, site definitions, resource files, |
| | | | Web Part files, and assemblies to process. |
| Outbound.aspx.txt | 19,758 | Mar. 08, | ASP.NET Server Page. Auto-generated |
| | | 2009 | file by Microsoft ® Visual Studio NET. |
| | | | Initiates web request for outbound calls. |
| | | | ASP.NET is a web application framework |
| | | | developed and marketed by Microsoft ® |
| | | | to allow programmers to build dynamic |
| | | | web sites, web applications and web |
| | | | services |
| PromptStrings.resx.txt | 7,150 | Sep. 23, | .NET Managed Resource File. Resource |
| | | 2009 | files. Program use this to help build UI. |
| | | | Useful for globalization/localization, or |
| | | | customization of resources for specific |
| | | | installs. |
| Reference.cs.txt | 68,048 | Sep. 25, | Visual C# source code. Contains various |
| | | 2009 | functions available for the present |
| | | | invention. |
| Reference.map.txt | 610 | Sep. 25, | Linker Address Map. The reference map |
| | | 2009 | is a class file that is auto-generated by a |
| | | | utility called WSDL.exe. This is where |
| | | | the URL for the XML Web Service is |
| | | | kept; it can either be static or dynamic. |
| Service.asmx.txt | 82 | Oct. 29, | ASP.NET Web service. Designer source |
| | | 2009 | code file implementing various aspects of |
| | | | the present invention; for example, for |
| | | | providing interfaces to external services |
| | | | such as email, SMS and web search. |
| Service.cs.txt | 184,831 | Oct. 28, | Visual C# source code file for XML web |
| | | 2009 | reference for implementing various |
| | | | aspects of the present invention. |
| Service.disco.txt | 771 | Sep. 25, | Web service Discovery file for |
| | | 2009 | implementing various aspects of the |
| | | | present invention. |
| Service.wsdl.txt | 37,794 | Sep. 25, | Web Service Description Language; |
| | | 2009 | XML file that provides a model for |
| | | | describing various aspects of the present |
| | | | invention. |
| Settings.Designer.cs.txt | 1,671 | Jun. 04, | Designer file for application settings; |
| | | 2009 | allows for dynamic storage and retrieval |
| | | | of property settings and other information |
| | | | for the application. |
| Settings.settings.txt | 506 | Jun. 04, | C# source code behind file for application |
| | | 2009 | settings. |
| VoiceDictation.cal.txt | 316 | Apr. 05, | This file includes pronunciation |
| | | 2009 | information; this is an editable version of |
| | | | a Custom Application Lexicon (CAL). |
| | | | When this file is compiled, a “.lex” file |
| | | | generated. |
| VoiceDictation.csproj.txt | 6,164 | Sep. 25, | Visual C# project file. Visual |
| | | 2009 | Studio .NET projects are used as |
| | | | containers within a solution to logically |
| | | | manage, build, and debug the items that |
| | | | comprise you application. The output of a |
| | | | project is usually an executable program |
| | | | (.exe), a dynamic-link library (.dll), file or |
| | | | a module, among others. |
| VoiceDictation.dll.config.txt | 881 | Jun. 04, | XML configuration file generated by the |
| | | 2009 | compiler and contains application |
| | | | settings. |
| VoiceDictation.gbuilder.txt | 1,258 | Mar. 08, | Microsoft ® Speech Server Grammar File. |
| | | 2009 | |
| VoiceDictation.grxml.txt | 3,579 | Sep. 25, | W3C XML (World Wide Web |
| | | 2009 | Consortium eXtensible Markup |
| | | | Language) Grammar File. The Speech |
| | | | Recognition Grammar Specification |
| | | | (SRGS) defines syntax for representing |
| | | | grammars for use in speech recognition |
| | | | so that developers can specify the words |
| | | | and patterns of words to be listened for by |
| | | | a speech recognizer. |
| VoiceDictation.PromptStrings.resources.txt | 1,281 | Oct. 28, | .NET Managed Resources File. |
| | | 2009 | |
| VoiceDictation.sln.txt | 22,108 | Oct. 28, | MS Visual Studio Solution. This file is |
| | | 2009 | created by Visual Studio IDE (integrated |
| | | | development environment). Organizes |
| | | | projects, project items and solution items |
| | | | into the solution by providing the |
| | | | environment with references to their |
| | | | locations on disk. |
| VoiceDictation.speax.txt | 91 | Jul. 16, | Includes information that instructs |
| | | 2009 | Internet Information Server (IIS) to load |
| | | | Speech Server to respond to the request, |
| | | | its contents tell Speech Server what class |
| | | | to load as your application. |
| VoiceDictation2.csproj.FileListAbsolute.txt | 824 | Sep. 29, | Auto generated by Visual Studio |
| | | 2009 | compiler and list absolute path |
| | | | to files and assemblies. |
| VoiceDictationHost.cs.txt | 2,946 | Jul. 16, | Visual C# source code File; demonstrates |
| | | 2009 | how to get input from a user using |
| | | | dictation by any phone without using |
| | | | keyboard and screen. |
| VoiceDictationPrompts.PrProj.txt | 528 | Mar. 08, | Prompt Project File. |
| | | 2009 | |
| VoiceDictationPrompts.txt | 188 | Mar. 12, | Auto-generated by the Visual Studio; |
| | | 2009 | RULES file which defines custom build |
| | | | steps. |
| VoiceDictationWorkFlow.designer.cs.txt | 43,800 | Sep. 23, | Visual C# source code file; required |
| | | 2009 | method for Designer support; auto |
| | | | generated by MS Visual Studio. |
| VoiceDictationWorkflow.rules.txt | 31,230 | Sep. 23, | Auto generated by the RULES file which |
| | | 2009 | defines custom build steps. |
| VoiceResponseWorkflow.cs.txt | 95,800 | Sep. 29, | Visual C# source code file. Main source |
| | | 2009 | file for speech workflow of the present |
| | | | invention. |
| WeatherForecast.discomap.txt | 411 | Jan. 29, | Web service Discovery file for weather |
| | | 2009 | forecast web service |
| WeatherForecast.wsdl.txt | 10,465 | Jan. 29, | Web Service Description Language |
| | | 2009 | forecast web service. |
| Web.Config.txt | 1,125 | Aug. 24, | XML Configuration File. Web.config is |
| | | 2009 | the main settings and configuration file |
| | | | for an ASP.NET web application. The file |
| | | | is an XML document that defines |
| | | | configuration information regarding the |
| | | | web application. The web.config file |
| | | | contains information that control module |
| | | | loading, security configuration, session |
| | | | state configuration, and application |
| | | | language and compilation settings. |
| | | | Web.config files can also contain |
| | | | application specific items such as |
| | | | database connection strings |

The Microsoft .NET Framework is a software framework available with several Microsoft Windows operating systems and includes a large library of coded solutions to prevent common programming problems and a virtual machine that manages the execution of programs written specifically for the framework.

The Session Initiation Protocol (SIP) is a signalling protocol, widely used for setting up and tearing down multimedia communication sessions such as voice and video calls over Internet Protocol (IP). Other feasible application examples include video conferencing, streaming multimedia distribution, instant messaging, presence information and online games. The protocol can be used for creating, modifying and terminating two-party (unicast) or multiparty (multicast) sessions consisting of one or several media streams. The modification can involve changing addresses or ports, inviting more participants, adding or deleting media streams, etc.

The SIP protocol is a TCP/IP-based Application Layer protocol. Within the OSI model it is sometimes placed in the session layer. SIP is designed to be independent of the underlying transport layer; it can run on TCP, UDP, or SCTP. It is a text-based protocol, incorporating many elements of the Hypertext Transfer Protocol (HTTP) and the Simple Mail Transfer Protocol (SMTP), allowing for easy inspection by administrators.

The public switched telephone network (PSTN) is the network of the world's public circuit-switched telephone networks, in much the same way that the Internet is the network of the world's public IP-based packet-switched networks. Originally a network of fixed-line analog telephone systems, the PSTN is now almost entirely digital, and now includes mobile as well as fixed telephones.

The session initiation protocol or “SIP” is an application-layer control protocol for creating, modifying, and terminating sessions between communicating parties. The sessions include Internet multimedia conferences, Internet telephone calls, and multimedia distribution. Members in a session can communicate via unicast, multicast, or a mesh of unicast communications.

The SIP protocol is described in Handley et. al., SIP: Session Initiation Protocol, Internet Engineering Task Force (IETF) Request for Comments (RFC) 2543, March, 1999, the disclosure of which is incorporated herein by reference in its entirety. A related protocol used to describe sessions 25 between communicating parties is the session description protocol. The session description protocol is described in Handley and Jacobsen, SDP: Session Description Protocol, IETF RFC 2327, April 1998, the disclosure of which is incorporated herein by reference in its entirety.

The SIP protocol defines several types of entities involved in establishing sessions between calling and called parties. These entities include: proxy servers, redirect servers, user agent clients, and user agent servers. A proxy server is an intermediary program that acts as both a server and a client 35 for the purpose of making requests on behalf of other clients. Requests are serviced internally or by passing them on, possibly after translation to other servers. A proxy interprets, and, if necessary, rewrites a request message before forwarding the request. An example of a request in the SIP 40 protocol is an INVITE message used to invite the recipient to participate in a session.

FIG. 8 illustrates a portion of the system of FIG. 1 in a greater detail. In particular, FIG. 8 is a schematic of the server 100 of FIG. 2 representing one possible physical embodiment of the present invention. Referring to FIG. 8, the server 100 includes a processor 170, a program code storage 172 connected to the processor 170, and the data storage 150 of FIG. 2, also connected to the processor 170. The program code storage 172 includes instructions for the processor 170 such that, when executed by the processor 170, the instructions case the processor 170 to perform the methods of the present invention including the steps illustrated in FIGS. 5, 6, and 7 and discussed above. Further, the program code storage 172 includes the program code for the functions 120 and the application 140 illustrated in FIG. 2. The data storage 150 includes user and system data as discussed elsewhere in this document. In another embodiment of the present invention, the program code storage 172 and the data storage 150 may be different portions of a single storage unit 175 as illustrated by dash-outlined storage unit 175 encompassing both the program code storage 172 and the data storage 150.

### CONCLUSION

From the foregoing, it will be appreciated that the present invention is novel and offers advantages over the existing art. Although a specific embodiment of the present invention is described and illustrated above, the present invention is not to be limited to the specific forms or arrangements of parts so described and illustrated. For example, differing configurations, sizes, or materials may be used to practice the present invention. The present invention is limited by the claims that follow. In this document, terms “voice” and “speech” are used interchangeably to mean sound or sounds uttered through the mouth of people, generated by a machine, or both.

We claim:

1. A method for processing speech from a user, the method comprising:
a. obtaining input from the user by converting the user's speech into text corresponding to the speech by
(1) receiving input audio stream from the user;
(2) converting the input audio stream to corresponding text;
(3) converting the corresponding text into an echo audio stream;
(4) providing the echo audio stream to the user; and
(5) repeating the steps a.(1) through a.(4) until the corresponding text includes an end-input command;
b. determining a desired operation within the corresponding text; and
c. performing the desired operation.

2. The method recited in claim 1 wherein the desired operation is sending an electronic message (email).

3. The method recited in claim 1 further comprising:
d. parsing the corresponding text to determine parameters of an electronic message including an addressee for the email; and
e. sending the email to the desired addressee.

4. The method recited in claim 1 wherein the desired operation is sending an SMS (Short Message Service) message.

5. The method recited in claim 1 further comprising:
d. parsing the corresponding text to determine parameters of SMS (Short Message Service) message;
e. dividing the corresponding text into multiple portions, each portion having a size that is less than a predetermined size; and
f. sending each portion of the corresponding text as a separate SMS message.

6. The method recited in claim 1 wherein the desired operation is sending an MMS (Multimedia Messaging Services) message.

7. The method recited in claim 1 wherein the desired operation is translating at least a portion of the corresponding text.

8. The method recited in claim 1 further comprising:
d. encoding an request, the request including information from the corresponding text;
e. sending the request to a web service machine;
f. receiving a response to the request;
g. converting the response to audio stream; and
h. sending the audio stream to the user.

9. A system for processing speech from a user, the system comprising a computing device connected to a communications network, the computing device comprising:
a processor;
program code storage;
data storage;
wherein the program code storage comprises instructions for the processor to perform the following steps:
a. obtaining input from the user by converting the user's speech into text corresponding to the speech by
(1) receiving input audio stream from the user;
(2) converting the input audio stream to corresponding text;
(3) converting the corresponding text into an echo audio stream;
(4) providing the echo audio stream to the user; and
(5) repeating the steps a.(1) through a.(4) until the corresponding text includes an end-input command;
b. determining a desired operation within the corresponding text; and
c. performing the desired operation.

10. The system recited in claim 9 wherein the desired operation is sending an electronic message (email).

11. The system recited in claim 9 wherein the program code storage further comprises further instructions:
d. parsing the corresponding text to determine parameters of an electronic message including an addressee for the email; and
e. sending the email to the desired addressee.

12. The system recited in claim 9 wherein the desired operation is sending an SMS (Short Message Service) message.

13. The system recited in claim 9 further comprising:
d. parsing the corresponding text to determine parameters of SMS (Short Message Service) message;
e. dividing the corresponding text into multiple portions, each portion having a size that is less than a predetermined size; and
f. sending each portion of the corresponding text as a separate SMS message.

14. The system recited in claim 9 wherein the desired operation is sending an MMS (Multimedia Messaging Services) message.

15. The system recited in claim 9 wherein the desired operation is translating at least a portion of the corresponding text.

16. The system recited in claim 9 further comprising:
d. encoding an request, the request including information from the corresponding text;
e. sending the request to a web service machine;
f. receiving a response to the request;
g. converting the response to audio stream; and
h. sending the audio stream to the user.

17. A method for obtaining input from a user, the method comprising:
a. providing a prompt to the user;
b. receiving input audio stream from the user;
c. converting the input audio stream to corresponding text;
d. providing improper input feedback to the user and repeating the method from step a or step b if the corresponding text is improper;
e. executing the editing command and repeating the method from step a or step b if the corresponding text is an editing command;
f. terminating the method for obtaining input if the corresponding text is an end-input command;
g. performing, if the corresponding text is input text, the following steps:
(1) saving the corresponding text;
(2) converting the corresponding text into an echo audio stream;
(3) sending the echo audio stream to the user; and
(4) repeating the method from step a or step b.

18. A system for obtaining speech from a user, the system comprising a computing device connected to a communications network, the computing device comprising:
a processor;
program code storage connected to the processor;
data storage connected to the processor;
wherein the program code storage includes instructions for the processor to perform the following steps:
a. receive input audio stream from the user;
b. convert the input audio stream to corresponding text;
c. provide improper input feedback to the user and repeat from step b if the corresponding text is improper;
d. execute the editing command and repeating the from step a if the corresponding text is an editing command;
e. terminate obtaining input from the user if the corresponding text is an end-input command;
f. perform, if the corresponding text is input text, the following steps:
(1) save the corresponding text;
(2) convert the corresponding text into an echo audio stream;
(3) send the echo audio stream to the user; and
(4) repeat from step a.

19. A method for processing speech from a user, the method comprising:
a. receiving input audio stream from the user;
b. converting the input audio stream to corresponding text;
c. converting the corresponding text into an echo audio stream;
d. saving the corresponding text;
e. providing the echo audio stream to the user;
f. repeating the steps a through d until the corresponding text includes a recognized command; and
g. performing the recognized command.
